(19) United States
(12) Patent Application Publication
(10) Pub. No.: US 2004/0195751 A1
(43) Pub. Date: Oct. 7, 2004

(54) Clamping device with position monitoring

(75) Inventor: Luciano Migliori, Milan (IT)

Correspondence Address: YOUNG & THOMPSON, 745 SOUTH 23RD STREET 2ND FLOOR, ARLINGTON, VA, 22202

(73) Assignee: UNIVER S.P.A., MILAN (IT)

(21) Appl. No.: 10/812,946

(22) Filed: Mar. 31, 2004

(30) Foreign Application Priority Data
Apr. 3, 2003 (IT) MI2003A 000655

(51) Int. Cl. B25B 5/10

(52) U.S. Cl. 269/244

(57) ABSTRACT

The clamping device for clamping work pieces comprises a box-shaped casing and a pivotally supported clamping arm operatively connected to a control actuator. The clamping device comprises at least a first and a second sensor for detecting and monitoring operative positions of the clamping arm; the sensors are adjustably fastened to a base plate comprising a plurality of anchoring bushes for the sensors spaced apart and aligned in a longitudinal direction of a base plate. Each sensor is removably secured to the base plate by fasteners, which engage with respective anchoring bushes.

### BACKGROUND OF THE INVENTION

This invention refers to a clamping device for clamping work pieces, and more in particular relates to an electrically or pneumatically operated clamping device, provided with a position detecting and/or monitoring control system.

### STATE OF THE ART

Clamping devices are normally used, for example in the automotive industry, for gripping work pieces which must be assembled, welded or subjected to working operations.

Clamping devices are described for example in EP 0.962.285 and in EP 0.636.449; a clamping device in general comprises a box-shaped casing onto which a clamping arm is pivotally connected to be angularly moved between a first back position, and a second forward position, for respectively releasing and retaining a work piece; the clamping arm is made to rotate by an electric or pneumatic actuator to which it is operatively connected by means of a toggle mechanism and a linearly movable thrust member.

Such devices are commonly used in complex systems for assembling parts of the bodywork of motor vehicles, which call for precise and perfectly controlled clamping actions, and which must be monitored by electronic control units according to established working programs.

It is therefore necessary to accurately control the working and/or the end-stroke positions of the clamping arm, and to provide suitable control signals for monitoring as well as for providing consent signals to a control unit governing the entire work cycle of the clamping device.

In order to allow the necessary control of the clamping arm, use was suggested, for example in U.S. Pat. No. 5,845,897, of a clamping device having a monitoring system for detecting the position of the clamping arm, comprising a first and a second control switches which can be attached in different positions to an L-shaped supporting rail insertable through a slot in the box-shaped casing of the clamping device.

The possibility of adjusting the position of the control switches offers considerable advantages as far as the functionality and flexibility of the clamping device are concerned.

In fact, in the event of the clamping device being operated electrically, the possibility of adjusting the position of the control switches makes it possible to selectively control the movement of the clamping arm, so as to be able to vary the releasing and retaining positions of the clamping arm, and to adapt the use of the clamping device to different operative conditions and/or for controlling its operative cycle.

In the event of a pneumatically operated clamping device, the possibility of adjusting the position of the control switches makes it possible to design a single switch supporting members for different types of clamping devices.

However, U.S. Pat. No. 5,845,897 does not describe how it is practically possible to adjust the position of the switches, nor does it even suggest a specific embodiment of the means allowing such adjustment.

### OBJECTS OF THE INVENTION

The object of this invention is to provide a clamping device for clamping work pieces, as mentioned previously, provided with means for monitoring and/or controlling the positions of the clamping arm, whereby it is possible to quickly and accurately adjust the position of the detection switches or sensors, anchoring them firmly in position to a removable support element, by simple fastening means which offer immediate access by an operator.

### BRIEF DESCRIPTION OF THE INVENTION

More precisely a clamping device for clamping work pieces has been provided comprising:

a box-shaped casing having a longitudinal axis;

a clamping arm pivotally connected the box-shaped casing, to angularly rotate between a first and a second operative position;

a control actuator operatively connected to the clamping arm; and

at least a first and a second sensor for monitoring the operative positions of the clamping arm, said sensors being adjustably fastened to a support device, in correspondence with an aperture in a side wall of the box-shaped casing, wherein said sensor support device comprises:

a longitudinally extending base member;

a plurality of side by side arranged anchoring bushes on said base member; and

fastening means, said fastening means being conformed and arranged for removably positioning each sensor to the base member and for fastening to a related anchoring bush.

### BRIEF DESCRIPTION OF THE DRAWINGS

These and further features of a clamping device with a monitoring and control device according to this invention, will be more clearly evident from the following description with reference to the accompanying drawings, in which:

FIG. 1 shows a clamping device with a position monitoring device according to this invention;

FIG. 2 shows a longitudinal sectional view of a first embodiment of the monitoring device;

FIG. 3 shows an exploded perspective view of the monitoring device of FIG. 2;

FIG. 4 shows a longitudinal cross-sectional view of a support plate for the sensors, along the line 4-4 of FIG. 7;

FIG. 5 shows an enlarged detail of FIG. 3;

FIG. 6 shows a front view of the support plate of FIG. 4;

FIG. 7 shows a rear view of the support plate of FIG. 4;

FIG. 8 shows a further embodiment of a support device for the sensors according to the invention.

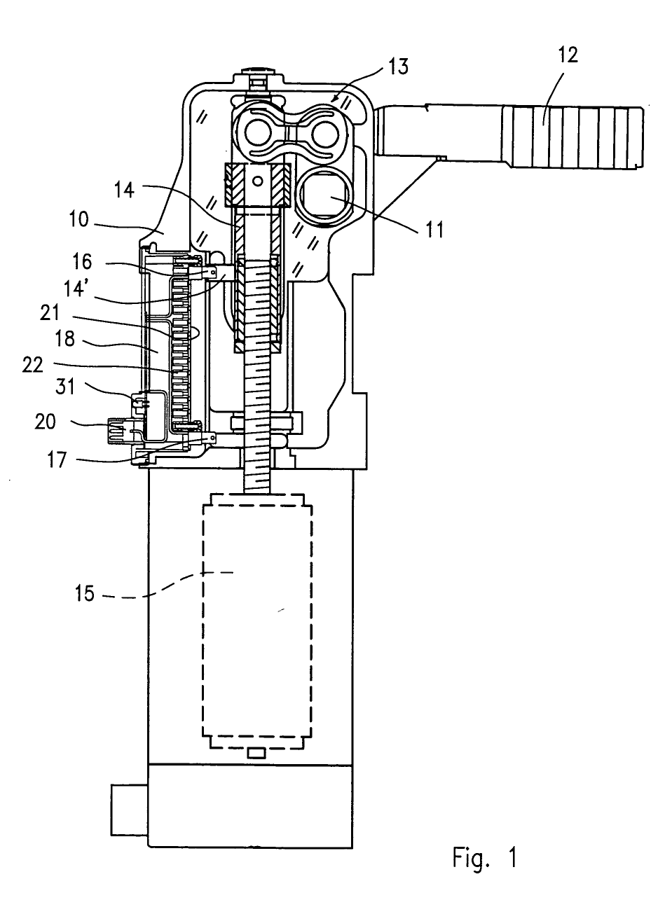

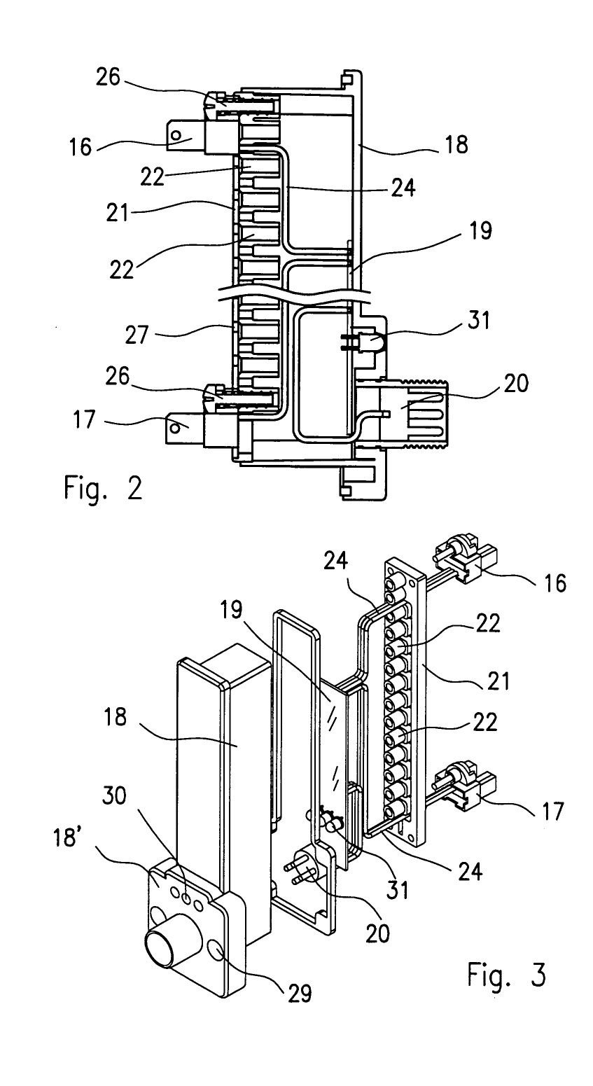

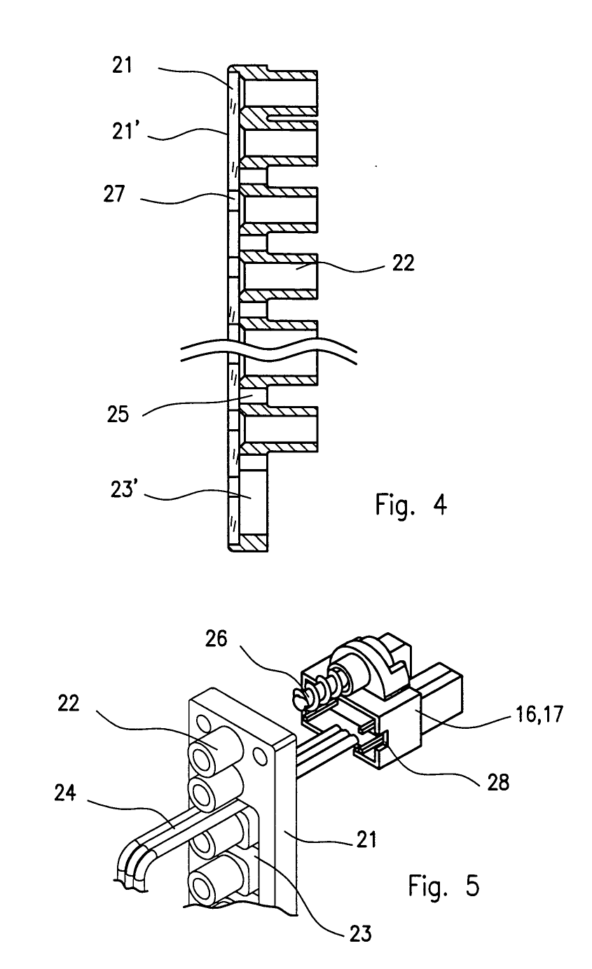

### DETAILED DESCRIPTION OF THE INVENTION

With reference to the figures from 1 to 7, a description will now be given of the general features, and a first particular embodiment of a clamping device provided with a monitoring and control device, according to this invention.

The clamping device comprises a box-shaped casing 10 having a longitudinal axis, onto which a clamping arm 12 for clamping work pieces, is pivoted at 11 to be angularly movable between a first operative position and a second operative position for respectively releasing and retaining a work piece, for example metal sheet or parts of a motor vehicle during assembling.

The clamping arm 12 is operatively connected, by means of a toggle lever mechanism 13, to a thrust member 14 movable along the longitudinal axis of the box-shaped casing 10; the thrust member 14 in turn is connected to a control actuator, for example an electric motor 15, or a pneumatic actuator, capable of moving the thrust member 14 between a backward and a forward position corresponding respectively to the releasing and retaining positions of the clamping arm 12.

In a clamping devices of the above mentioned type, at each operation it is necessary to carry out a check of the positions of the thrust member 14 and the clamping arm 12, to provide an electronic control unit (not shown) with control signals indicative of the “open” and “closed” conditions of the clamping device, and with a consent signal to carry out the required working operations.

For such purpose, the clamping device is provided with a position detecting device for the thrust member 14, and the clamping arm 12; said detecting device, shown in the exploded view in FIG. 3, comprises a support member 21 for adjustably securing at least a first and a second detector switch or sensor 16, 17, which can be adjustably fastened in different positions to a support member 21; said support member 21 is removably secured to a case 18 which can be tightly inserted into an aperture in a side wall of the box-shaped casing 10 of the device.

More precisely, the first sensor 16 detects the position of the thrust member 14 in which the clamping arm 12 retains and locks a work piece, while the second sensor 17 detects the position of the thrust member 14 in which the work piece is released by the clamping arm 12.

The detecting sensors 16,17 are preferentially of the optical type, which offer greater detecting precision and are not influenced by outer magnetic fields, but they may also be of any different type, for example of inductive, capacitive, or other type.

The activation of the sensors 16,17 can be achieved in any appropriate way, for example by providing on the thrust member 14, in the case of optical sensors, a flag 14′ capable of intercepting or reflecting the light beam emitted by each sensor 16,17.

The sensors 16,17 are operatively connected to an electronic or printed circuit 19, which in turn can be connected by means of a plug 20 to an electronic control unit of the clamping device.

The supporting base member for the sensors 16, 17 may consist of a supporting plate 21 having a sensor anchoring face 21′ which extends longitudinally.

Preferentially, the anchoring face 21′ of the plate 21 for supporting the sensors 16,17, is facing towards the thrust member 14, with an aligned disposition parallel to the longitudinal axis of the box-shaped casing 10; however, other orientations are not excluded.

The sensor support plate 21, as shown in FIG. 4, on the side opposite to the face 21′ comprises a plurality of anchoring bushes 22 for anchoring the sensors 16,17, which are side by side arranged and spaced apart from each other. The bushes 22 are aligned in the direction of the aforesaid longitudinal axis; the bushes 22 are provided with axial through holes which extend from one side of the base plate 21, towards the inside of the case 18, in order to limit the overall dimensions.

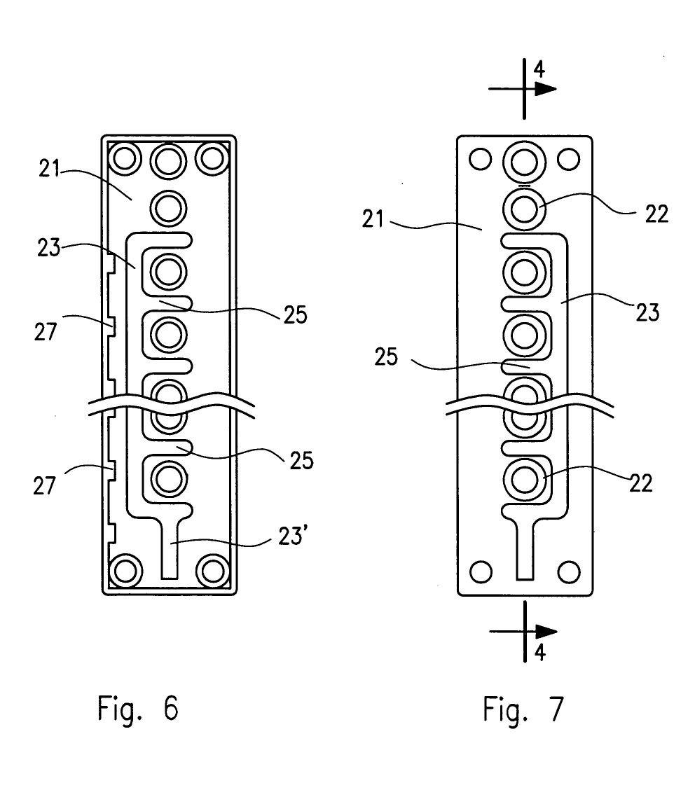

The base plate 21, as shown in FIGS. 6 and 7, is also provided with a comb-shaped slot 23 for the 10 passage of electric wires 24 for the connection of the sensors 16,17 to an electric power supply printed circuit 19, housed inside the case 18.

The slot 23 for the passage of the wires 24 extends along one side of the bushes 22 in a direction parallel to the aforesaid longitudinal axis, and is provided with a plurality of cross slots 25 which extend between adjacent anchoring bushes 22.

Each sensor 16,17 is removably secured to the support base plate 21, by fastening means comformed and arranged to be engageable and disengageable with a respective anchoring bush 22, while allowing a correct positioning of the sensor in respect to the base plate.

The aforesaid fastening means preferably comprise a fastening screw 26 rotatably supported by a sleave 16′ of the body of each sensor 16,17, which engages by screwing into a respective anchoring bush 22, thereby preventing any accidental detachment or movement of the sensors 16,17.

Consequently, adjustment of the position of the sensors 16,17 is carried out quickly and easily, by positioning and anchoring each sensor 16,17 to an appropriate bush 22 so as to enable the positioning of the sensors 16,17 in compliance with the operative requirements of the clamping device.

In order to easily fastening the sensors 16,17, the clamping device can be provided with means for positioning the sensors 16,17 along the support base plate 21. For example can comprise a side tooth 27 in correspondence with each anchoring bush 22; the teeth 27 are disposed laterally on the anchoring face 21′ of the supporting plate 21, spaced apart from one another according to the space between the anchoring bushes 22.

Correspondingly, the body of each sensor 16,17 comprises a side cavity 28 engageable with a respective one of said positioning teeth 27 when the sensor 16,17 is secured to the base plate 21 in a position aligned to an anchoring bush 22.

Consequently, the sensors 16,17 can be anchored in a accurate way also by an inexperienced operator, in that the positioning teeth 27 and cavities 28 identify both the correct position of the sensors 16,17 in correspondence with each anchoring bush 22, and the exact orientation of the sensors themselves, thanks to the fact that the teeth 27 and the cavities 28 must be on the same side of the support plate 21.

Thanks to the presence of the slots 23 and 25 in the support plate 21, the electric wires 24 of the sensors 16, 17 are tidy and do not hamper the positioning of the sensors 16,17 along the plate 21.

Preferentially, the slot 23 for the passage of the wires 24 extends at least to one axial end of the supporting plate 21, with a central portion 23′ aligned with the anchoring bushes 22, so as to facilitate the positioning of the sensors 16, 17 and the relevant wires 24 in correspondence with the end position along the support plate 21.

Preferentially, the case 18 for housing the power supply circuit 19 and the base plate 21, is provided with a widened portion 18′ having holes 29 for the passage of screws for fastening the case 18 to the box-shaped casing 10 of the clamping device, and holes 30 through which light emitting diodes 31 (LED) are displayed for providing indications relating to specific operative conditions of the clamping device.

Depending upon requirements, or the chosen clamping device, the anchoring bushes 22 for anchoring the sensors 16, 17 can either be disposed at regular or at variable space, for example progressively increasing, starting from one end of the plate 21, according to the angle of aperture required for the clamping arm 12.

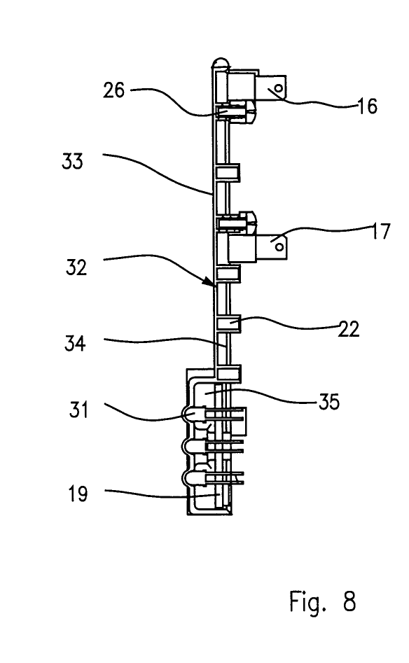

A second embodiment of a support element for the sensors according to the invention is shown in FIG. 8, in which the same reference numbers have been used to indicate similar or equivalent parts.

In particular, the base member for supporting the sensors 16, 17 is in the form of a box-shaped body 32 having a rear wall 33 and a peripheral wall 34, and a plurality of anchoring bushes 22 for the sensors 16, 17 which extend from one side of the rear wall 33, extending beyond the peripheral wall 34.

The support box 32 for the sensors 16, 17 at one end also comprises a cavity 35 for housing an electric circuit 19 for supplying power to the sensors 16, 17.

Also in this case, the sensors 16, 17, preferentially of the optical type, are engageable with a respective anchoring bush 22 by means of screw fasteners 26.

It is understood that what has been described and shown with reference to the accompanying drawings, has been given purely by way of example in order to illustrate the general features and some solutions, without this being understood in a restrictive sense.

Therefore, other modifications or variations may be made to the shape and to the structure of the clamping device, or to the monitoring device, in comformity with the claims.

What we claim is:

1. Clamping device for clamping work pieces of the type comprising:
a box-shaped casing having a longitudinal axis;
a clamping arm, pivotally connected by the box-shaped casing to angularly rotate between a first and a second operative position;
a control actuator, operatively connected to the clamping arm; and
at least a first and a second sensor for monitoring the operative positions of the clamping arm, said sensors being adjustable fastened to a support device, in correspondence with an elongated aperture in a side wall of the box-shaped casing of the clamping device, wherein said sensor support device comprises:
a longitudinally extending base member;
a plurality of side by side arranged anchoring bushes on said base member; and
fastening means, said fastening means being conformed and arranged for positioning each sensor to the base member and for removably fastening each sensor to a related anchoring bush.

2. A clamping device according to claim 1, wherein said support device for the sensors comprises a base plate having a longitudinally extending sensor anchoring face;
said sensor anchoring bushes laterally protruding from one side of said base plate;
a slot for wires passage longitudinally extending on the base plate along one side of said plurality of anchoring bushes, and a plurality of cross slots each extending between adjacent anchoring bushes.

3. A clamping device according to claim 2, wherein said anchoring bushes for the sensors extend from the base plate, inside a box-shaped case housing a power supply circuit.

4. A clamping device according to claim 2, wherein positioning means for the sensors, are provided said positioning means comprising a cavity on the body of each sensor, and a related engaging tooth on the base plate 21, in correspondence with each anchoring bush.

5. A clamping device according to claim 2, wherein the slot for the passage of the electric wires, at one end of the base plate, extends with a slot portion aligned with the anchoring bushes.

6. A clamping device according to claim 1, wherein the sensor support device comprises box-shaped body having a rear wall defining said base member, and a peripheral wall said anchoring bushes extending from the rear wall, beyond said peripheral wall.

7. A clamping device according to claim 6, wherein the box-shaped body for supporting the sensors comprises a cavity for housing a power supply electric circuit, at one end.

8. A clamping device according to claim 1, wherein said sensor fastening means are of screw type.

9. A clamping device according to claim 1, wherein said sensors are of the optical type.
